(19) United States
(12) Patent Application Publication
(10) Pub. No.: US 2012/0086273 A1
(43) Pub. Date: Apr. 12, 2012

(54) DYNAMIC THERMOSTATIC CONTROL OF SMALL-SCALE ELECTRICAL LOADS FOR MATCHING VARIATIONS IN ELECTRIC UTILITY SUPPLY

(76) Inventor: Roger W. Rognli, Otsego, MN (US)

(21) Appl. No.: 13/252,747

(22) Filed: Oct. 4, 2011

Related U.S. Application Data
(60) Provisional application No. 61/389,557, filed on Oct. 4, 2010.

(51) Int. Cl. H02J 4/00

(52) U.S. Cl. 307/43

(57) ABSTRACT

A method of dynamically controlling a small-scale electrical load receiving energy from an electricity grid that includes sources of renewable generation causing variations in electricity supply of the electricity grid. The small-scale electrical loads are coupled to a load-matching thermostat having a communication module and a controller that manage electricity load to electrical supply for the electrical load.

### RELATED APPLICATION

The present application claims the benefit of U.S. Provisional Application No. 61/389,557 filed Oct. 4, 2010, which is incorporated herein in its entirety by reference.

### FIELD OF THE INVENTION

The present invention relates generally to management and control of electrical loads. More particularly, the present invention relates to dynamic thermostatic control of small-scale electrical loads to match variations in electricity supply.

### BACKGROUND OF THE INVENTION

Utilities need to match generation to load, or supply to demand. Traditionally, this is done on the supply side using Automation Generation Control (AGC). As loads are added to an electricity grid and demand rises, utilities increase output of existing generators to solve increases in demand. To solve the issue of continuing long-term demand, utilities invest in additional generators and plants to match rising demand. As load levels fall, generator output to a certain extent may be reduced or taken off line to match falling demand. Although such techniques are still used, and to a certain extent still address the problem of matching supply with demand, as the overall demand for electricity grows the cost to add power plants and generation equipment that serve only to fill peak demand makes these techniques extremely costly. Further, the time required to increase generator output or to take generators online and take generators offline creates a time lag, and a subsequent mismatch between supply and demand.

In response to the limitations of AGC, electric utility companies have developed solutions and incentives aimed at reducing both commercial and residential demand for electricity. In the case of office buildings, factories and other commercial buildings having relatively large-scale individual loads, utilities incentivize owners with differential electricity rates to install locally-controlled load-management systems that reduce on-site demand. Reduction of any individual large scale loads by such a load-management systems may significantly impact overall demand on its connected grid.

In the case of individual residences having relatively small-scale electrical loads, utilities incentivize consumers to allow demand response technology to be installed at the residence to control high-usage appliances such as air-conditioning compressors, water heaters, pool heaters, and so on. Demand response thermostats allow a utility company to control operation of heating ventilating and air conditioning (HVAC) loads. For example, while a consumer might set a thermostat to a particular set point, during a time of peak usage, a utility may ramp the set point temperature upwards so as to avoid turning on an air-conditioning compressor.

Such technology aids the utilities in easing demand during sustained periods of peak usage. However, the impact of reducing any individual load does not significantly reduce overall demand or overall load on the supplying electrical grid, and there remains no easy way to quickly and collectively coordinate reducing loads of numerous, disparate residential customers having individually insignificant load demand. Consequently, reducing overall load on a grid by controlling small-scale loads remains challenging.

Furthermore, the challenges associated with matching load to generation have been exacerbated by the growing use of renewable energy sources. Renewable generation, primarily wind and solar, is not controllable to the same degree as conventional generation. Changing wind speeds and solar intensities cause renewable generators to produce electricity at variable, and sometimes unpredictable, rates. Further, many state governments are requiring utilities to install significant levels of renewable generation, thus heightening the challenges of balancing load and generation.

One attempt to address the volatility in renewable generation and its effect on electricity grids includes storing excess energy in batteries for later use. Another attempt relies on load-shifting. A typical example of load-shifting involves hydro-pumping, or using available excess electricity to pump water to a point above ground, then during times of lower supply and higher demand, allow the water to flow down to ground level to generate electricity. Although storage and load-shifting techniques offer an interim solution, significant capital must be invested, efficiency will be compromised, and real-time matching of load and generation remains elusive.

### SUMMARY OF THE INVENTION

Embodiments of the present invention include methods, devices and systems for collectively and dynamically thermostatically controlling small-scale electrical loads so as to match a collective load demand with variations in electricity supply.

In an embodiment, the present invention comprises a method of controlling a small-scale electrical load receiving energy from an electricity grid that includes sources of renewable generation causing variations in electricity supply of the electricity grid. The small-scale electrical load is coupled to a load-matching thermostat that manages electricity load to electrical supply for the electrical load. In such an embodiment, the method includes providing a runtime temperature offset of the load-matching thermostat; determining a load-start temperature based upon a set-point temperature and the runtime temperature offset; sensing a first parameter of the electricity supply; and causing the load-matching device to automatically adjust the runtime temperature offset of the load-matching thermostat based upon the first parameter of the electricity supply, thereby adjusting the load-start temperature.

In another embodiment, the present invention comprises a load-matching thermostat to dynamically control a small-scale electrical load receiving energy from an electricity grid that includes sources of renewable generation causing variations in electricity supply so as to manage electricity load to the variable electricity supply. In such an embodiment, the thermostat includes: an electricity supply sensor that senses a first parameter of an electricity supply; a temperature sensor that senses a space temperature of a premise where the load-matching thermostat is located; and a controller that causes an electrical load to receive power when the space temperature substantially reaches a set point temperature plus a runtime temperature offset. The controller may be configured to receive the first parameter from the electricity supply sensor and adjust the runtime temperature offset in response to the first parameter, thereby changing a temperature at which the electrical load receives power.

In another embodiment, the present invention comprises a load-matching thermostat to dynamically control a small-scale electrical load receiving energy from an electricity grid that includes sources of renewable generation causing variations in electricity supply so as to manage electricity load to the variable electricity supply. The thermostat comprises: means for providing a runtime temperature offset of the load-matching thermostat; means for determining a load-start temperature based upon a set-point temperature and the runtime temperature offset; means for sensing a first parameter of the electricity supply; and means for causing the load-matching device to automatically adjust the runtime temperature offset of the load-matching thermostat based upon the first parameter of the electricity supply, thereby adjusting the load-start temperature.

In another embodiment, the present invention comprises a non-transitory, computer-readable medium storing instructions for implementing a method of controlling a small-scale electrical load receiving energy from an electricity grid that includes sources of renewable generation causing variations in electricity supply of the electricity grid, the small-scale electrical load coupled to a load-matching thermostat that manages electricity load to electrical supply for the electrical load. The method comprises the steps: providing a runtime temperature offset of the load-matching thermostat; determining a load-start temperature based upon a set-point temperature and the runtime temperature offset; sensing a first parameter of the electricity supply; and causing the load-matching device to automatically adjust the runtime temperature offset of the load-matching thermostat based upon the first parameter of the electricity supply, thereby adjusting the load-start temperature.

### BRIEF DESCRIPTION OF THE DRAWINGS

The invention may be more completely understood in consideration of the following detailed description of various embodiments of the invention in connection with the accompanying drawings, in which:

FIG. 1 is a diagram of an electricity generation and distribution grid that includes sources of renewable energy connected to the grid, according to an embodiment of the present invention;

FIG. 2 is a diagram of a premise having an electrical load controlled by a dynamic temperature offset control system, according to an embodiment of the present invention;

FIG. 3 is a block diagram of a load-matching thermostat, according to an embodiment of the present invention;

FIG. 4a is a graph depicting demand versus time for the case of an incremental rise in demand;

FIG. 4b is a graph depicting temperature offset versus time corresponding to the case of an incremental rise in demand as depicted in FIG. 4a;

FIG. 5a is a graph depicting demand versus time for the case of an incremental fall in demand;

FIG. 5b is a graph depicting temperature offset versus time corresponding to the case of an incremental fall in demand as depicted in FIG. 5a;

FIG. 6 is a flowchart of a temperature offset adjustment process according to an embodiment of the present invention;

FIG. 7a is a graph depicting demand versus time for an extended period of time and for the case of multiple changes in demand;

FIG. 7b is a graph depicting temperature offset versus time for an extended period of time and for the case of multiple changes in demand as depicted in FIG. 7a;

FIG. 8 is a diagram of the electricity generation and distribution grid of FIG. 1, depicting various zones of control;

FIG. 9a is a graph depicting temperature offset versus time for an extended period of time and for the case of changing frequency; and

FIG. 9b is a graph depicting frequency versus time for an extended period of time and corresponding to the temperature offset graph of FIG. 9a.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

Embodiments of the present invention include methods, systems, and devices for dynamically matching electrical loads with electrical supply by controlling temperature offsets of thermostatic devices. Such methods, systems and devices include controlling operations of the electrical loads by adjusting temperature offsets based on local and remote inputs.

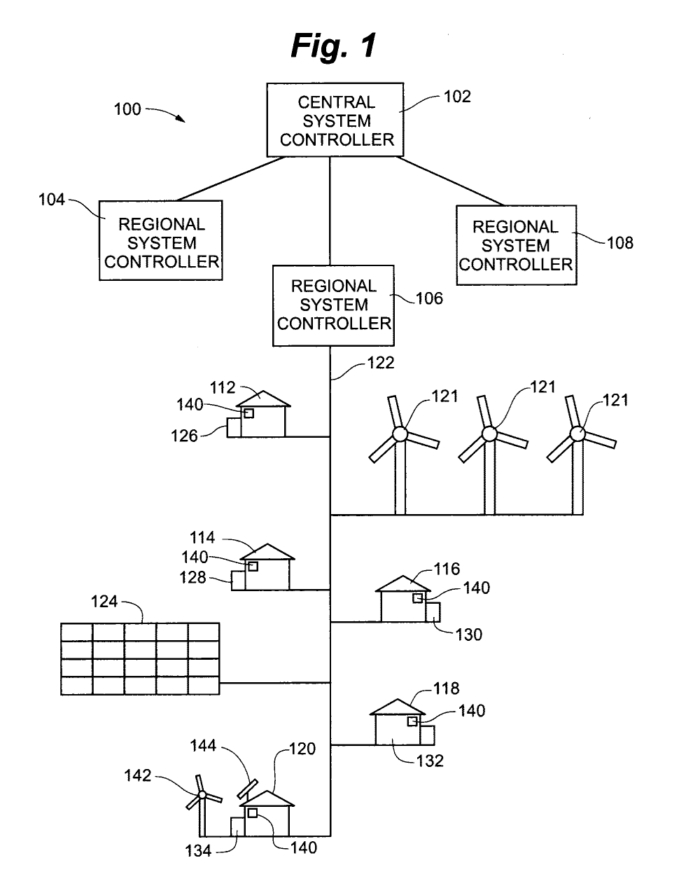

Referring to FIG. 1, an electricity generation and distribution grid 100 is depicted. Grid 100 includes central system controller 102 in communication with multiple regional system controllers 104, 106, and 108. In an embodiment, central system controller 102 comprises a power generation plant having centralized control over generation and distribution of electrical power throughout grid 100. In other embodiments, central system controller 102 may not be the point of generation, but comprises a centralized point of control and communication. Regional system controllers 104, 106 and 108 may be substations or other distribution and/or control points for controlling generation and distribution of electricity to regional areas, in conjunction with central system controller 102.

Each regional system controller 104, 106, and 108 controls distribution, and in some cases generation, of electricity over a regional sub-grid to a plurality of users. In the embodiment depicted, premises 112, 114, 116, 118 and 120 receive energy over distribution network 122, forming a regional sub-grid. Regional sources of renewable energy, such as wind turbines 121 and solar panel array 124, or other such renewable sources, may also be connected to sub-grid 110 via distribution network 122, thus supplying energy to sub-grid 110 and grid 100.

Each of the plurality of premises 112, 114, 116, 118 and 120 include at least one small-scale electrical load 126, 128, 130, 132, and 134, respectively, that draws energy from grid 100. Small-scale electrical loads include not only electrical loads of residential buildings, such as single-family homes, but may also include electrical loads of multi-unit housing complexes, smaller office buildings, farms, light-commercial and retail buildings. In these types of applications, small-scale electrical loads draw less than 250 kW of electrical power. Although grid 100 may also include large-scale electrical loads, such as those concentrated at factories and other commercial sites, such loads are not the subject of the present invention. Hereinafter, the term “electrical load” will generally be understood to refer to small-scale electrical loads utilizing less than 250 kW.

Electrical loads 126 to 134 may be individually controlled by a thermostat or thermostat-like device. In an embodiment, electrical loads 126 to 134 comprise HVAC loads, such as compressors or resistive heaters. In other embodiments, electrical loads 126 to 134 may comprise other types of compressor-based loads or resistive loads controllable by a thermostat.

In the depicted electricity supply system of grid 100, each load 126 to 134 is controlled by a load-matching thermostat (LMT) 140 of the present invention, the details of which will be discussed further below.

In some embodiments, a premise might also include premise-located renewable energy sources. As depicted, premise 120 includes two types of renewable energy generators, wind turbine 142, and solar panel 144. In an embodiment, premise wind turbine 142 comprises a micro-turbine. Such generators typically provide electrical energy to premise 120, and in many cases, may connect directly to distribution network 122 to supply excess power to grid 100.

Unlike traditional electricity grids that may only include a single generation source, such as a centralized power plant connected to multiple electrical loads, grid 100 includes multiple generation sources as well as multiple controlled and uncontrolled loads. The renewable energy sources supply power to grid 100 dependent on local conditions. Turbines 121 supply relatively more power to grid 100 on windy days, while solar array 124 supplies more power on sunny days. Matching electricity supply to demand becomes increasingly difficult as the relative amount of volatile renewable energy sources connected to grid 100 grows.

As discussed above, previous solutions for matching electricity supply and demand rely on either increasing supply, or decreasing demand. Increasing supply generally consists of bringing additional generation online or increasing generator output, while decreasing demand commonly consists of reducing peak-time loading through the use of technology such as demand response thermostats or relays. On the other hand, the present invention provides load-based solutions to balance electricity supply and demand by not only decreasing load demand on grid 100 when electricity supply is down, but also by increasing load on grid 100 when supply is up. However, in embodiments, LMT 140 may work in conjunction with known demand response technology.

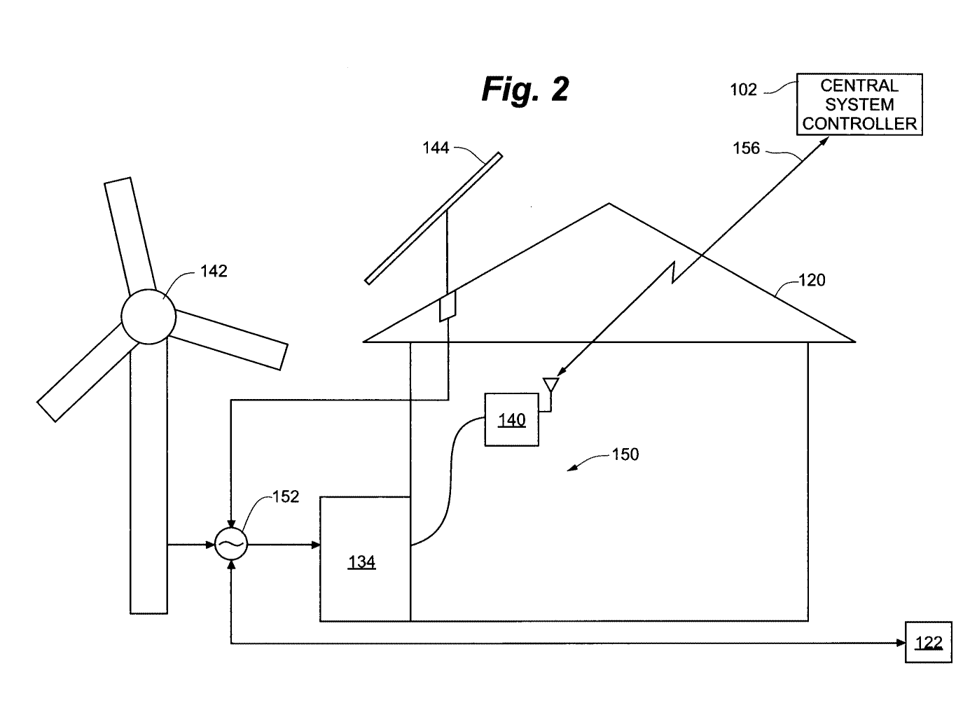

Referring to FIG. 2, an embodiment of a dynamic thermostatically-controlled load-matching system 150 at premise 120 is depicted. System 150 includes power source 152 coupled to grid 122 and optionally to renewable sources 142 and 144, load-matching thermostat (LMT) 140, and load 134. Power source 152 provides power to load 134, which is controlled by LMT 140. LMT 140 in some embodiments communicates with central system controller 102 (as depicted), or with another remote controller, such as a regional system controller 104, 106, or 108 (see FIG. 1), over communications network 156.

Power source 152 as depicted is a simplified representation of multiple sources of power, including power supplied from grid 100 via distribution network 122, and power from local renewable energy sources, which in the depicted embodiment includes wind turbine 142 and solar panel 144. Although not depicted, power source 152 may also include inverters and other power conditioning and control equipment related to premise wind turbine 142 and solar panel 144 as needed to supply power to premise 120 and potentially to grid 100.

Network 156 is linked to central system controller 102, and facilitates one-way or two-way communications, with transmission of data accomplished using a variety of known wired or wireless communication interfaces and protocols including power line communication (PLC), broadband or other interne communication, radio frequency (RF) communication, and others.

In an embodiment, communications network 156 comprises a one-way or two-way long-haul network, such as an RF network transmitting and receiving data via radio towers. Network 156 can be implemented with various communication interfaces including, for example, VHF or FLEX one-way paging, AERIS/TELEMETRIC Analog Cellular Control Channel two-way communication, SMS Digital two-way communication, or DNP Serial compliant communications for integration with SCADA/EMS communications currently in use by electric generation utilities.

In other embodiments, communications network 156 comprises a short-haul network employing a variety of wired or wireless network topologies, and protocols. Though not exhaustive, this includes wireless mesh networking, and a variety of associated wireless protocols such as ZigBee®, Wi-Fi®, Z-Wave®, Bluetooth®, and others.

In yet other embodiments, communications network comprises both a short-haul and a long-haul network.

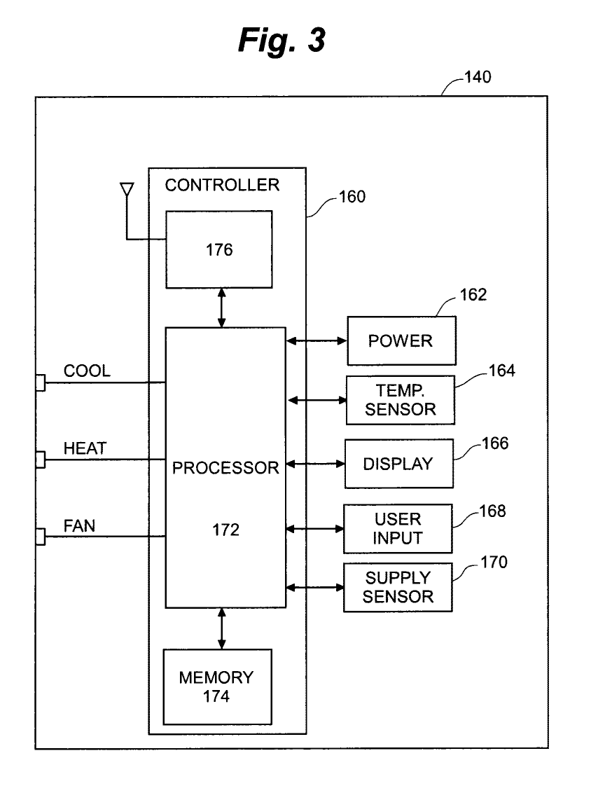

Referring also to FIG. 3, a block diagram of an embodiment of LMT 140 is depicted. As depicted, LMT 140 includes a controller 160, power circuitry 162, temperature sensor 164, optional display 166, user input 168, and optional supply sensor 170. Power circuitry 162, temperature sensor 164, display 166, user input 168 and supply sensor 170 are electrically and communicatively coupled to controller 160.

Controller 160 includes one or more processors 172 electrically and communicatively coupled to memory 174 and communications module 176. Processor 172 includes several control outputs for sending control signals to load 134, including, COOL, HEAT, and FAN. In certain embodiments, processor 172 may be a central processing unit, microprocessor, microcontroller, microcomputer, or other such known computer processor. Memory 174 may comprise various types of volatile memory, including RAM, DRAM, SRAM, and so on, as well as non-volatile memory, including ROM, PROM, EPROM, EEPROM, Flash, and so on. Memory 174 may store programs, software, and instructions relating to the operation of LMT 140.

Communications module 176, communicatively coupled to processor 172, facilitates receipt and/or transmission of messages over communications network 156. Communications module 176 may include a combination of hardware, software, and firmware and may be a separate module, distinct from controller 160, or in other embodiments may be integrated into controller 160.

Communications module 176 may include a transceiver which functions as a receiver and a transmitter, or just a receiver. In one embodiment, communications module 176 is both a receiver and a transmitter, receiving and transmitting data over a two-way communications network 156. In other embodiments, communications module 176 includes only a receiver, receiving data over a one-way communications network. In yet other embodiments, communications module 176 receives only over network 156, and transmits over an alternate short-haul network (not depicted). Such a short-haul network might be located at premise 120 and used to facilitate communication between LMT 140 and load 134, or other communicative devices at premise 120.

When communications network 156 includes a short-haul network, communications module 176 in one embodiment may be a stand-alone transceiver chip, such as a ZigBee transceiver chip that includes integrated components, such as a microcontroller and memory, as well as a ZigBee software stack.

In embodiments wherein communications network 156 includes both a short-haul network and a long-haul network, LMT 140 may include more than one transceiver to facilitate communications between the long-haul and the short-haul network.

In some embodiments, wherein communications network 156 is not a radio frequency network, and is a network such as a PLC, DSL, or other such wired network, communications module 176 may comprise a translation device that serves as a gateway or translator that facilitates communication between master controller 102 and LMT 140, rather than a traditional RF transceiver.

Power circuitry 162 provides power to devices and components of LMT 140, and may comprise any combination of alternating or direct current power.

Temperature sensor 164 may be internal or external to LMT 140, and provides input to controller 160 and processor 172 such that the space temperature inside premise 120 may be determined. Hereinafter, the term “space temperature” will refer to the air temperature of the space conditioned by, or otherwise affected by, load 134. It will also be understood that “space temperature” also refers broadly to the temperature of other mediums affected by load 134, such as water in the case of a load 134 that heats or cools water.

Display 166 displays information to a consumer of LMT 140, such as set point temperature, space temperature, time, energy cost, and other such information. In some embodiments, display 166 may be an interactive display, such as a touch-screen display.

User input 168 provides an interface between a user and LMT 140. In some embodiments, user input 168 is a keyboard allowing a use or occupant of premise 120 to input control and other information to LMT 140, including set point temperature, fan settings, and so on. In some embodiments, input 168 comprises an occupant-selectable fan control that permits a consumer or occupant to select occupant-selectable fan settings, including AUTO, CIRCULATE, ON, and OFF. In other embodiments, user input 168 may include portions of display 166, such as when display 166 is a touch-screen display, or one or more switches.

Supply sensor 170, when present, may be integrated into LMT 140, or may be external to LMT 140. Supply sensor 170 senses or measures one or more parameters relating to electricity supply. Such parameters may include frequency, voltage, amperage, power quality, and so on. When renewable generation sources are present, supply sensor 170 may also sense an amount of energy being used at premise 120, or by load 134 alone, as compared to the output of local renewable sources. In one embodiment, supply sensor 170 detects line-under or line-over frequency (LOUF). In another embodiment, supply sensor 170 detects line-under or line-over voltage (LOUV).

In general operation, and in its thermostatic role, LMT 140 controls the space temperature of premise 120 by controlling the operation of one or more loads 134. For the case of load 134 being a cooling load, such as an AC compressor, when temperature sensor 164 detects that a space temperature has risen sufficiently above a set point temperature, LMT 140 sends a control signal via terminal COOL to load 134, causing load 134 to be powered, thereby providing cool air to premise 120 and lowering the space temperature to the desired set point temperature.

Similarly, for the case of load 134 being a heating load, when temperature sensor 164 detects that a space temperature has fallen sufficiently below a set point temperature, LMT 140 sends a control signal via terminal HEAT to load 134, causing load 134 to turn on, thereby providing warm air to premise 120 and raising the space temperature to the set point temperature.

Unlike traditional thermostats, LMT 140 includes dynamic, real-time adjustability of cooling and/or heating loads through the use of temperature offsets. Dynamically adjusting temperature offsets according to methods of the present invention can increase or decrease load on a grid 100, especially when multiple loads 134 are controlled by multiple LMTs 140.

In one embodiment, temperature offset may be defined as the difference between a displayed space temperature and a measured space temperature, and may be zero, positive, or negative. For a case where the temperature offset is +1° F. and the measured space temperature is 71° F., the resulting displayed space temperature is 72° F. For a case where a temperature offset is −1° F., and the measured space temperature is 71° F., the resulting displayed space temperature is 70° F. In other words, in embodiments with non-zero temperature offsets, rather than display the actual temperature inside a premise as measured at the location of temperature sensor 164, the temperature displayed is an adjusted temperature that reflects the temperature offset of LMT 140. Further, in one embodiment, set point temperature is also adjusted by temperature offset such that when a user sets the desired set point temperature to an adjusted set point temperature, such that in operation a displayed space temperature eventually reaches a displayed set point temperature.

In some traditional thermostats, a static calibration adjustment between measured temperature and displayed temperature may exist. However, any such known calibration adjustments for traditional thermostats remain static, and unchanged after initial installation.

In contrast, LMI 140, by dynamically controlling the magnitude of temperature offsets, adjusts the timing of the powering of loads 134, i.e., load-start times, such that loads 134 power earlier or later as compared to control using non-adjustable temperature offsets, thereby manipulating or adjusting short-term electrical demand on grid 100. The temperature offsets may be manipulated up and down based on power supply parameters, such as those sensed by supply sensor 170, or otherwise input to LMT 140. This causes the sum of loads 134 on grid 100 to be dynamically changed to match variations in supply. Such variations in supply may be due to the short-term volatility inherent in renewable energy sources, including wind gusts, cloud cover, and so on.

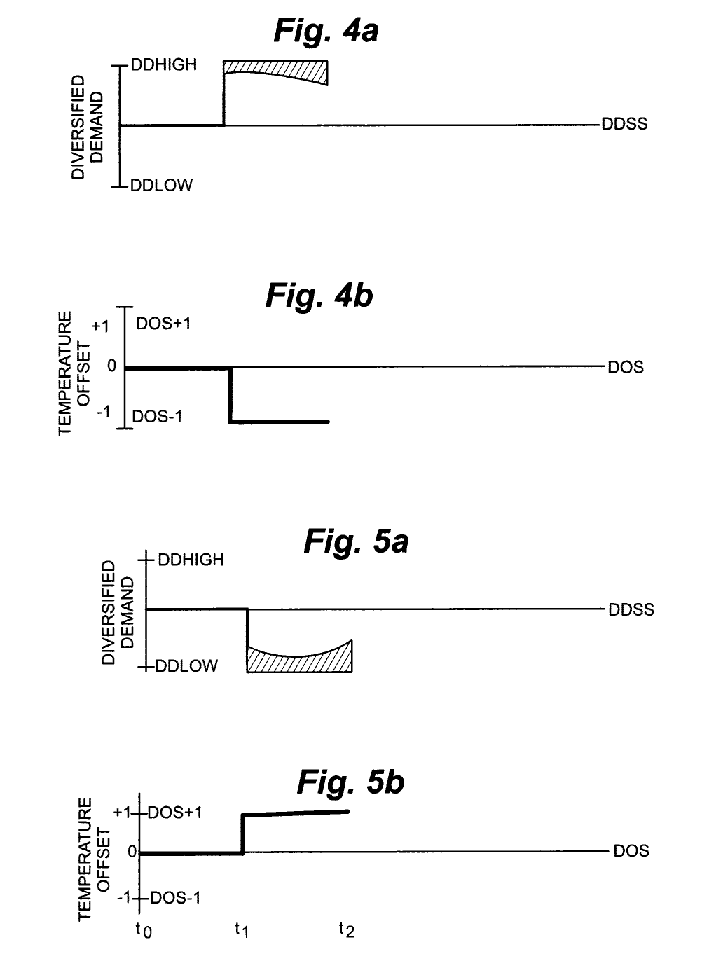

Referring to FIGS. 4a to 5b, an illustration of a thermostat in heating mode is depicted. Reducing the magnitude of a temperature offset will bring on extra load (increase demand) for a short period of time, while increasing the magnitude of a temperature offset will lower load (decrease demand) for a short period of time. This illustration applies to heating, though cooling demand can be controlled by adjusting the offsets in the opposite direction.

Still referring to FIGS. 4a to 5b, the basic relationships between temperature offset and energy demand is illustrated. In this description of FIGS. 4a to 5b, the temperature offset will be assumed to be a heating temperature offset, though the same principles apply to a cooling temperature offset.

Referring specifically to FIGS. 4a and 4b, a graph of diversified demand versus time is illustrated in FIG. 4a, and a corresponding graph of temperature offset, referred to as Runtime Offset (ROS), versus time is illustrated in FIG. 4b. Diversified demand refers to the sum of energy demand created by a plurality of loads 134 connected to grid 100. The same description applies to any individual load 134, though the impact of an individual load 134 on grid 100 will generally be minimal. ROS refers to the actual, real-time temperature offset being actively applied to a load 134.

Referring to both FIGS. 4a and 4b, at time t₀, diversified demand is at a steady state level DD_{SS} while the ROS is at a Default Offset (DOS). Such a DOS may be programmed into LMTs 140 initially and/or communicated to LMTs 140 at any point in time. After systems 150 have reached a steady state with a temperature offset of DOS, then the diversified demand levels off to a steady state diversified demand level (DD_{SS}), the demand level that it would have been without a temperature offset.

At time t₁, if ROSₜ₀ is decreased from default DOS to a lower value, DOS−1 degree, as depicted, then individual loads 134 that have been waiting for the space temperature to drop by DOS no longer have to wait as long, and may be powered sooner, some immediately. The result is a rapid rise in diversified demand at t₁ to DD_{HIGH} for a period of time as LMTs 140 allow loads 134 to be powered on. Consequently, demand for energy is dynamically “created” in the short-term by decreasing a temperature offset.

Eventually, loads 134 are powered off as the space temperature reaches the set point temperature, and diversified demand decays towards DD_{SS} as depicted at time t₂.

Referring to FIGS. 5a and 5b, the effect of increasing runtime temperature offset ROS above the default offset DOS is depicted. Again, at t₀, steady state conditions apply such that diversified demand is at DDss , and ROSt₀ is initially at DOS. During this steady state, loads 134 will be turning on as needed after space temperature drifts upwards by an ROS equal to the default DOS. Likewise, loads 134 will turn off as set point temperatures are reached. In other words, during a steady state, although all loads share a common runtime temperature offset, loads 134 are not running synchronously, nor turning on and off synchronously.

At time t₁, in this embodiment, ROS for all loads is increased to DOS+1. At that point in time, t₁, some individual loads 134 may be powered already because space temperature rose to set point temperature plus a previous offset of DOS, and others will not be powered. Loads that are powered already may or may not be forced to power down. Those loads that were waiting to be powered will wait longer.

Consequently, the increase in ROS from DOS to DOS+1 at t₁ causes demand to begin to fall from DDss to DD_{LOW} as more and more loads 134 are delayed, thus reducing demand by increasing a temperature offset for LMTs 140 and their loads 134.

As space temperatures drift upwards to a temperature of set point plus DOS+1, loads 134 will begin to be powered, and demand begins to rise somewhat in the latter portion of the period between time t₁ and time t₂, approaching the steady state demand DDss . The exact shape of the demand curve will vary in part based upon the actual characteristics of temperature drifts occurring in individual premises 120.

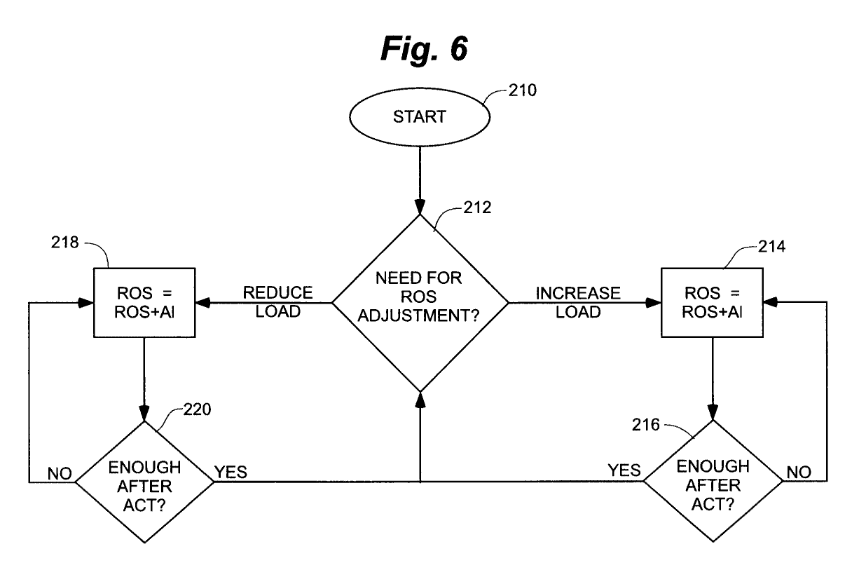

Referring to FIG. 6, a process for dynamically adjusting temperature offset, referred to as runtime temperature offset ROS, in a heating mode is depicted. After starting at step 210, a determination of the need for a temperature offset ROS adjustment is made at step 212. This determination will be described further below, but generally, a need to increase or decrease load will drive an adjustment in temperature offset.

If there is a need to increase load to match supply, at step 214, ROS will be decreased by an adjustment increment (AI). If this were a cooling application, ROS would be increased by an adjustment increment (AI). Whether the ROS decrement is sufficient is determined at step 216. At step 216, the determination is made after an adjustment cycle time (ACT). The ACT is defined as the number of cycles or time between temperature offset determinations, which in one embodiment is substantially equal to one AC power cycle. The ACT may be decreased for increased system sensitivity, and increased for decreased system sensitivity. If the decrement is insufficient, ROS is again decreased by AI at step 214, until the decrement is sufficient. Once the temperature offset ROS is determined to be sufficient, at step 212, the temperature offset ROS is reevaluated.

If at step 212 it is determined that the load needs to be reduced to match dwindling supply, at step 218, ROS will be increased by one AI (decreased for a cooling application). If at step 220 the adjustment to ROS is considered insufficient, the ROS is again increased at step 218. Steps 218 and 220 repeat until ROS is sufficiently increased and load sufficiently reduced.

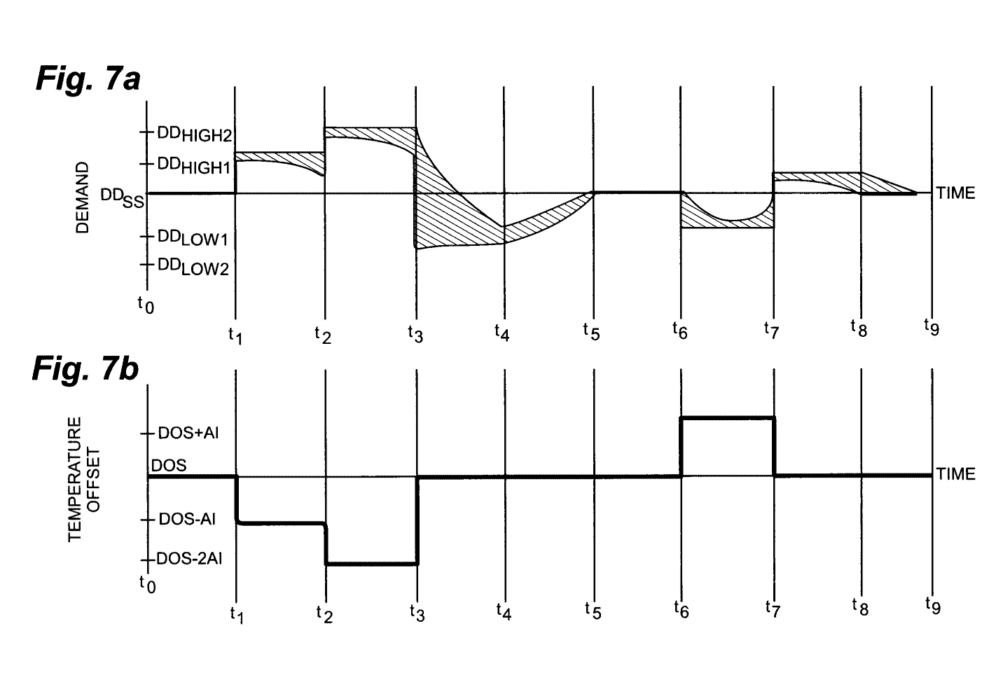

Referring to FIGS. 7a and 7b, using the process of FIG. 6 for increasing and decreasing demand, a utility may continuously adjust the load on grid 100 by increasing or decreasing the Runtime Offset ROS. Although this particular embodiment depicts the relationship between temperature offset and demand for a heating application, with an increase in offset resulting in a decrease in demand, a similar relationship exists for cooling applications, except that an increase in offset results in an increase in demand. When the ROS is decreased, there is a corresponding increase in load (demand) for some amount of time, then as that load gets satisfied, the increased demand decays back to the steady state diversified demand of the load. If however, the ROS is decreased farther, another increase in demand occurs.

Such an effect is illustrated from time t₀ to time t₃. At time t₀, ROS starts at a steady state value of DOS, then falls at time t₁by one adjustment increment AI to DOS-AI for one time period. During this time period, from time t₁ to t₂, the diversified demand rises abruptly from DDss to DD_{HIGH1}, then begins to decay towards DDss. Prior to reaching DDss, at time t₂, ROS is increased again by an increment AI, such that the ROSₜ₂=DOS−2AI. Subsequently, at time t₂, diversified demand increases to DD_{HIGH2}, then begins to decay towards DDss over the time period starting at t₂ and ending at t₃.

If the ROS is suddenly increased, the load on grid 100 drops. Those loads 134 that are resistive loads, and that may have turned on prior to an increase in ROS, may be forced off within the time difference between the prior and new ROS, being forced off for the additional time difference. Such a feature may be referred to as a re-shed capability. In other embodiments, such resistive loads 134 may not be forced off, depending on the needs of the utility. For compressor loads 134, such as AC or refrigeration loads, in an embodiment, such loads may not be forced off again once they have been powered up so as to avoid short-cycling and possible damage to the compressor load. As a result, the overall demand decrease resulting from an increase in ROS may be more gradual than the corresponding demand increase resulting from a decrease in ROS. In some embodiments, and as discussed further below, the re-shed capability may be a parameter or identifier programmed into the firmware or software of LMT 140.

Such an increase in ROS is depicted at t₃, wherein the ROS at time t₃, ROSₜ₃, is increased by two adjustment increments to DOS. Subsequently, diversified demand begins to decay downwards past DD_{SS} to a point DD_{LOW1}. As the ROS remains constant from time t₃ to t₅, diversified demand rises again to DD_{SS}.

At time t₆, another decrease in demand is desired, and the ROS is increase by another increment AI such that ROSₜ₆=DOS+AI, causing diversified demand to decrease over the first portion of the cycle bounded by t₆ and t₇. As ROS remains constant over this time period, diversified demand begins to rise again during the latter portion of the cycle.

At time t₇, ROS is decreased by an increment AI, causing another increase in demand, followed by a gradual decay to DDss from time t₇ to time t₉, as ROS is held constant at DOS.

Such dynamic temperature offset adjustments may be made based on real-time and predicted variations in electricity supply due to renewable generation so as to continuously match grid load to supply. As discussed briefly above, a number of supply parameters may be considered when determining and controlling the temperature offset of LMTs 140.

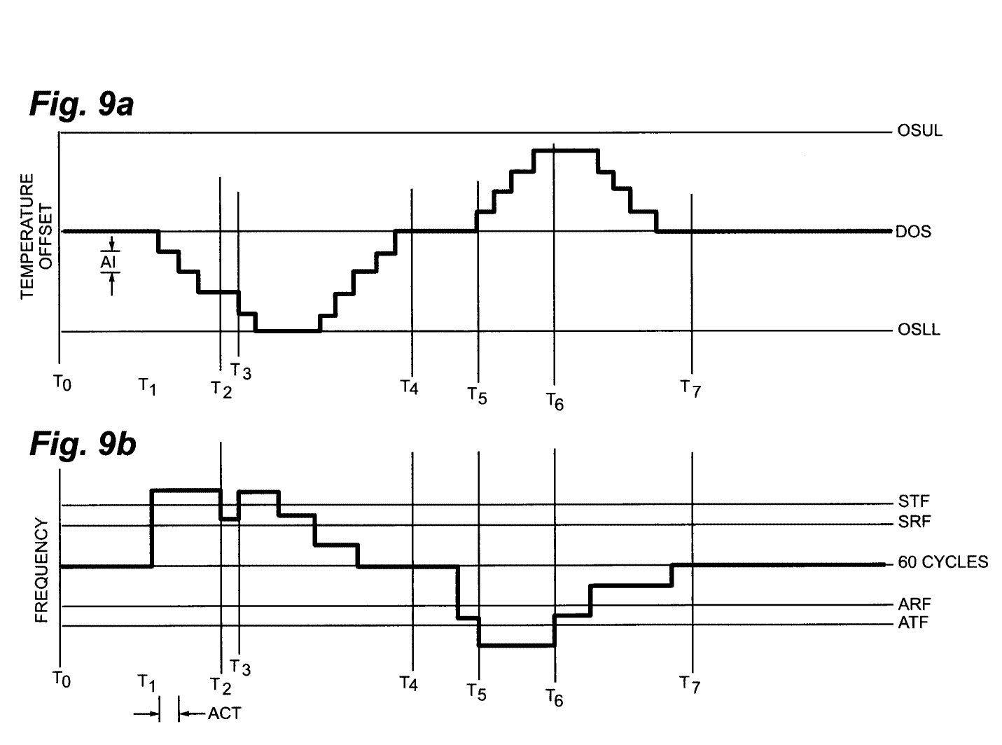

Although FIGS. 7a and 7b show ROS adjustments happening at discrete time intervals, and with discrete ROS steps, it will be understood that both the time intervals and ROS steps can be decreased and approach zero, effectively giving continuous control. A single command or other trigger may also cause the ROS to change in a continuous fashion, such as by linearly increasing, or by utilizing other higher-order functions, rather than purely in the step-like fashion depicted. This is illustrated in FIGS. 9a and 9b below.

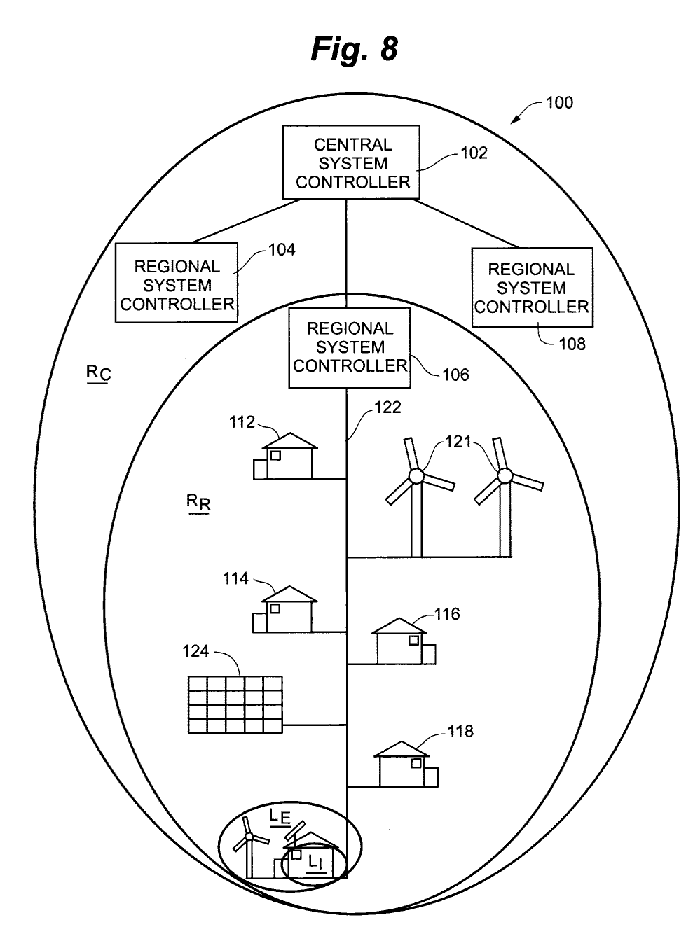

Referring to FIG. 8, a number of triggers or parameters may be used to determine and control the implementation of temperature offset or ROS. In one embodiment, parameters used to determine a temperature offset may be grouped into local and remote categories as follows: local internal depicted in region L₁ of FIG. 8, local external depicted in region L_{E}, remote regional depicted in region R_{R}, and remote central depicted in region R_{C}. Any combination of these categories of parameters may be used to determine changes in temperature offsets and control of its implementation.

Local internal control parameters may include power parameters such as frequency, voltage, amperage, or power factor as measured at or near premise 120, and possibly at particular loads 134. Often, when the electrical load on a grid 100 begins to rise above an optimal level, supply power frequency decreases and/or supply voltage decreases. Power factors may also decrease. During such times, demand begins to exceed supply, and LMT 140 may dynamically increase its temperature offset until such locally measured parameters indicate that demand more closely matches supply.

As will be discussed further below, LMT 140 may sense line-under frequency or voltage conditions through local supply sensor 170, or through other sensing devices coupled to power source 152. Alternatively, power supply information may be sensed by supply sensors 170 located remotely, and such information communicated to LMT 140 via network 156.

Similarly, when local power conditions indicate over frequency or over voltage conditions, supply typically exceeds demand. In such a situation, temperature offset may dynamically be shortened, or eliminated altogether, in order to bring load online as quickly as possible.

Local external parameters used to determine temperature offset of an individual premise LMD 140 may include parameters relating to local, primarily external factors. In an embodiment, LMD 140 includes the ability to receive a local signal from a device or system located at or near premise 120 and adjust a temperature offset based on the received signal and its corresponding data. Data may include information relating to premise-generated electricity, premise-consumed electricity, solar intensity, wind speed, and so on, as received from premise inverters, meters, outdoor sensors, and other communicative sensing and consuming equipment located at or near premise 120. Such data may be received by communications module 166 of LMT 140 over a local or short-haul, wired or wireless network as discussed above with reference to FIGS. 2 and 3. Such data may be processed at LMT 140 or processed remotely and provided to LMT 140.

In an embodiment, LMT 140 receives a signal from a photovoltaic system, or solar panel 144 of FIG. 2, indicating real-time electricity generation. In response to a relatively high output of energy, in some cases greater than the current needs of premise 120, a temperature offset of LMT 140 may be decreased to increase load.

Further, an LMT 140 after determining an appropriate temperature offset for itself based on local internal parameters may communicate information or instructions to other local or remote LMTs 140 over a short-haul network, or via the long-haul network 156, or to regional controller 106 and/or central controller 102, as depicted in FIG. 2.

As such, temperature offset may be adjusted and controlled at a local level based on premise internal and external parameters.

In an embodiment, temperature offsets for LMTs 140 may also be determined based on remote regional or remote system-wide considerations, for example, frequency or voltage at a substation, such that multiple LMTs 140 adjust their own individual temperature offsets based on these additional considerations. In other embodiments, regional system controllers 104, 106, 108 and/or central system controller 102 may determine and broadcast a common temperature offset for each LMT 140 to use so as to accommodate regional or central considerations.

Referring still to FIG. 8, with respect to regional considerations and control, LMTs 140 located within a particular region, or connected to a particular distribution line 122, may be supplied with regional information in order to determine an appropriate temperature offset. Such information may include information about regional voltage or frequency levels, and may be communicated from regional controllers 106 or central controller 102 via network 156 (see FIG. 2). In an embodiment, each LMT 140 may determine its own temperature offset by combining received remote information with local information. In another embodiment, LMTs 140 receive commands to set their individual temperature offsets per received command data such that all LMTs 140 in a particular region or area operate with the same temperature offset.

In some embodiments, once an LMT 140 determines an appropriate temperature offset and course of action, it sends information and/or instructions to other LMTs 140 in a local area, regional area, or system-wide. It may accomplish this by rebroadcasting its own control information, including temperature offset, to LMTs 140 sharing an appropriate group address. The priority of such control messages may be at a lower priority than local commands.

Further, control may also be initiated or adjusted at a system level, from central system controller 102, based on parameters, load levels, frequency, voltage and other information available at a system level and disseminated to LMDs 140.

Consequently, each LMT 140 may factor in local and remote data to determine an appropriate temperature offset so as to dynamically match load to supply. Local information or parameters include parameters particular to premise equipment and devices (“local internal”) as well as local external parameters, such as wind, solar intensity, and so on. Remote information may include regional and system-wide parameters, including electricity quality parameters such as voltage, frequency, power factor, and so on.

Referring to FIGS. 9a and 9b, a pair of graphs depicting a dynamic adjustment of temperature offset based on power frequency is depicted. More specifically, FIG. 9a depicts temperature offset versus time, and FIG. 9b depicts frequency versus time.

As discussed above, temperature offset may be adjusted using a number of local and remote parameters. Such parameters may include power quality parameters measured locally or regionally. As such, a line-over or line-under voltage (LOUV) or a line-over or line-under frequency (LOUF) process may be used to dynamically adjust temperature offset. In an embodiment, temperature offset may be set to a specified time as commanded by a regional or central controller, or other controlling/requesting device, or may be incrementally increased or decreased.

In the embodiment depicted in FIGS. 9a and 9b, power line frequency is monitored and temperature offset adjusted accordingly. In one embodiment, frequency may be monitored at a local premise 120 for adjusting temperature offset at a particular, individual LMT 140, or in an alternate embodiment may be monitored at a regional location such as a substation, and the temperature offsets of multiple LMTs 140 are commonly adjusted. Some examples of monitoring LOUV and LOUF and shedding a load in response are found in U.S. Pat. No. 7,242,114 and U.S. Pat. No. 7,595,567 commonly assigned to the assignee of the present application, and are herein incorporated by reference in their entireties.

For the purposes of illustration, and for implementing a temperature offset adjustment process in an algorithm of LMT 140, a number of terms which may be commands of LMT 140, are defined as follows: Runtime Offset as described above is the offset of LMT 140 at any given time; Default Offset as also described above is defined as the target normal offset, which may be zero, or some level set by an installer, or otherwise set; Offset Lower Limit (OSLL) is defined as the lower limit of the offset range, which in one embodiment is DOS−1 degree; Offset Upper Limit (OSUL) is defined as the upper limit of the temperature offset range; Adjustment Cycle Time (ACT) as also described above is the number of cycles or time, in some embodiments, milliseconds, between offset calculations; Adjustment Increments (AI) as also described above is the temperature in degrees to be adjusted (added or subtracted) each cycle; Add Trigger Frequency (ATF) is defined as the frequency below which AI is added to the ROS when OSUL>ROS>DOS; Add Trigger Voltage (ATV) is defined as the voltage below which AI is added to the ROS when OSUL>ROS>DOS; Add Restore Frequency (ARF) is defined as the frequency above which AI is subtracted from the ROS when OSUL>RDI>DOS; Add Restore Voltage (ARV) is defined as the voltage above which AI is subtracted from the ROS when OSUL>RDI>DOS; Subtract Trigger Frequency (STF) is defined as the frequency above which AI is subtracted from the ROS when DOS>ROS>OSLL; Subtract Trigger Voltage (STV) is defined as the voltage above which AI is subtracted from the ROS when DOS>ROS>OSLL; Subtract Restore Frequency (SRF) is defined as the frequency below which AI is added to the ROS when DOS>ROS>OSLL; Subtract Restore Voltage (SRV) is defined as the voltage below which AI is added to the ROS when DOS>ROS>OSLL; Re-shed capability (as discussed above) is indicated by the bit 0 or 1 to indicate if a controlled load is allowed to be turned off quickly after starting in response to an increase in ROS; and priority is an indication of whether a frequency driver or voltage driver takes priority at a given time.

Further, with respect to priority, in an embodiment, LMT 140 will prioritize commands coming in from local internal, local external, regional remote, and central remote levels. Those received commands may have priorities assigned to them in such a way that if the priority exists in the message, the priority should be used, but if there is no priority in the message, a stored priority of LMT 140 is used.

It will be understood that although FIGS. 9a, 9b and the corresponding description refer to an adjustment process based on frequency parameters, a similar process may be implemented using corresponding voltage parameters.

Referring still to both FIGS. 9a and 9b, frequency versus time and temperature offset (ROS) versus time are respectively plotted for a time period T₀ to T₇. At time T₀, steady-state conditions, measured frequency is at 60 Hz, and temperature offset is set to a default value, DOS.

At T₁, frequency increases beyond the Subtract Trigger Frequency (STF), indicating an excess supply of energy. ROS is subsequently dropped one adjustment increment (AI) for each Adjustment Cycle Time (ACT) in order to add demand to match the excess supply. At time T₂, in response to the decrease in ROS, the frequency drops down between the STF and the Subtract Restore Frequency (SRF), and ROS is held constant until time T₃.

At time T₃, frequency rises again above the STF, and ROS is shortened or adjusted downward, limited by the OSUL, until the frequency is at a value between the STF and the SRF, during which time ROS is held constant. As the frequency falls below the SRF between times T₃ and T₄, ROS is incremented by AI until the ROS reaches DOS at T₄, and a steady state is again reached.

One cycle before T₅, the frequency falls below the ATF. In response, one cycle later, the ROS is increased by AI for each cycle ACT until either the ROS hits the OSUL or the frequency rises above the ATF. If the frequency stays between the SRF and the ARF, then the ROS will remain constant and the demand will decay to the DD_{SS}, as it does between time T₆ and T₇.

Similar logic holds if the parameters are based on the voltage, or even another parameter, including power quality, is used.

Accordingly, the present invention provides methods, devices and systems for collectively and dynamically controlling small-scale electrical loads using temperature offsets so as to match a collective load demand with variable supply.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of controlling a small-scale electrical load receiving energy from an electricity grid that includes sources of renewable generation causing variations in electricity supply of the electricity grid, the small-scale electrical load coupled to a load-matching thermostat that manages electricity load to electrical supply for the electrical load, the method comprising:
providing a runtime temperature offset of the load-matching thermostat;
determining a load-start temperature based upon a set-point temperature and the runtime temperature offset;
sensing a first parameter of the electricity supply;
causing the load-matching device to automatically adjust the runtime temperature offset of the load-matching thermostat based upon the first parameter of the electricity supply, thereby adjusting the load-start temperature.

2. The method of claim 1, wherein sensing a first parameter of the electricity supply comprises sensing a frequency of the electricity supply.

3. The method of claim 1, wherein sensing a first parameter of the electricity supply comprises sensing a voltage of the electricity supply.

4. The method of claim 1, wherein sensing a first parameter of the electricity supply comprises sensing a power factor of the electricity supply.

5. The method of claim 1, wherein sensing a first parameter of the electricity supply comprises sensing a first parameter of the electricity supply at a remote location.

6. The method of claim 1, wherein sensing a first parameter of the electricity supply comprises sensing a first parameter of the electricity supply at a premise where the electrical load is located.

7. The method of claim 1 further comprising sensing a second parameter of the electricity supply, and causing the load-matching thermostat to automatically adjust the runtime thermostat offset based upon the first and the second parameter.

8. The method of claim 1, wherein providing a runtime temperature offset of the load-matching thermostat comprises receiving a runtime thermostat offset at a communication module of the load-matching thermostat, the runtime thermostat offset transmitted over a communications network by a remote controller.

9. The method of claim 1, wherein causing the load-matching thermostat to automatically adjust the runtime temperature offset based upon the first parameter comprises increasing the thermostat offset so as to decrease load on the electricity supply.

10. The method of claim 1, wherein causing the load-matching thermostat to automatically adjust the runtime temperature offset based upon the first parameter comprises decreasing a temperature offset so as to increase load on the electricity supply.

11. A load-matching thermostat to dynamically control a small-scale electrical load receiving energy from an electricity grid that includes sources of renewable generation causing variations in electricity supply so as to manage electricity load to the variable electricity supply, the thermostat comprising:
an electricity supply sensor that senses a first parameter of an electricity supply;
a temperature sensor that senses a space temperature of a premise where the load-matching thermostat is located;
a controller that causes an electrical load to receive power when the space temperature substantially reaches a set point temperature plus a runtime temperature offset, the controller being configured to receive the first parameter from the electricity supply sensor and adjust the runtime temperature offset in response to the first parameter, thereby changing a temperature at which the electrical load receives power.

12. The load-matching thermostat of claim 11, wherein the runtime thermostat offset is a positive temperature offset.

13. The load-matching thermostat of claim 11, wherein the runtime thermostat offset is a negative temperature offset.

14. The load-matching thermostat of claim 11, further comprising a communications module.

15. The load-matching thermostat of claim 14, wherein the communications module is configured to receive the runtime temperature offset as transmitted from a remote source over the communications network.

16. The load-matching thermostat of claim 11, wherein the electrical load comprises a compressor of a heating, ventilating and air-conditioning system.

17. The load-matching thermostat of claim 11 further comprising a processor configured to adjust the runtime thermostat offset based on the first parameter.

18. The load-matching device of claim 11, wherein the electricity supply sensor is configured to sense a first parameter that includes a frequency condition of the electricity supply.

19. The load-matching device of claim 11, wherein the electricity supply sensor is configured to sense a first parameter that includes a voltage condition of the electricity supply.

20. The load-matching device of claim 11, wherein the first parameter of the electricity supply is a parameter measured at a remote location.

21. The load-matching device of claim 11, wherein the electricity supply sensor is integral to the load-matching thermostat.

22. A load-matching thermostat to dynamically control a small-scale electrical load receiving energy from an electricity grid that includes sources of renewable generation causing variations in electricity supply so as to manage electricity load to the variable electricity supply, the thermostat comprising:
means for providing a runtime temperature offset of the load-matching thermostat;
means for determining a load-start temperature based upon a set-point temperature and the runtime temperature offset;
means for sensing a first parameter of the electricity supply; and
means for causing the load-matching device to automatically adjust the runtime temperature offset of the load-matching thermostat based upon the first parameter of the electricity supply, thereby adjusting the load-start temperature.

23. The load-matching thermostat of claim 22, wherein the means for sensing a first parameter of the electricity supply comprises means for sensing a first parameter selected from the group consisting of a frequency of the electricity supply, a voltage of the electricity supply, and a power factor of the electricity supply.

24. The load-matching thermostat of claim 22, wherein the means for causing the load-matching thermostat to automatically adjust the runtime temperature offset based upon the first parameter comprises increasing the thermostat offset so as to decrease load on the electricity supply.

25. The load-matching thermostat of claim 22, wherein the means for causing the load-matching thermostat to automatically adjust the runtime temperature offset based upon the first parameter comprises decreasing a temperature offset so as to increase load on the electricity supply.

26. The load-matching thermostat of claim 22, further comprising means for sensing a second parameter of the electricity supply, and causing the load-matching thermostat to automatically adjust the runtime thermostat offset based upon the first and the second parameter.

27. A non-transitory, computer-readable medium storing instructions for implementing a method of controlling a small-scale electrical load receiving energy from an electricity grid that includes sources of renewable generation causing variations in electricity supply of the electricity grid, the small-scale electrical load coupled to a load-matching thermostat that manages electricity load to electrical supply for the electrical load, the method comprising the steps:
providing a runtime temperature offset of the load-matching thermostat;
determining a load-start temperature based upon a set-point temperature and the runtime temperature offset;
sensing a first parameter of the electricity supply; and
causing the load-matching device to automatically adjust the runtime temperature offset of the load-matching thermostat based upon the first parameter of the electricity supply, thereby adjusting the load-start temperature.

28. The non-transitory, computer-readable medium of claim 27, wherein the method step of sensing a first parameter of the electricity supply comprises sensing one of a frequency of the electricity supply, a voltage of the electricity supply, or a power factor of the electricity supply.

29. The non-transitory, computer-readable medium of claim 27, wherein the method further comprises sensing a second parameter of the electricity supply, and causing the load-matching thermostat to automatically adjust the runtime thermostat offset based upon the first and the second parameter.

30. The non-transitory, computer-readable medium of claim 27, wherein the method step of providing a runtime temperature offset of the load-matching thermostat comprises receiving a runtime thermostat offset at a communication module of the load-matching thermostat, the runtime thermostat offset transmitted over a communications network by a remote controller.

31. The non-transitory, computer-readable medium of claim 27, wherein the method step of causing the load-matching thermostat to automatically adjust the runtime temperature offset based upon the first parameter comprises increasing the thermostat offset so as to decrease load on the electricity supply.
